(19) United States
(12) Patent Application Publication
(10) Pub. No.: US 2023/0017931 A1
(43) Pub. Date: Jan. 19, 2023

(54) NAVIGATION INFORMATION DEVICE AND METHOD

(71) Applicant: Furuno Electric Co., Ltd., Nishinomiya (JP)

(72) Inventors: Akito Ueshina, Nishinomiya (JP); Tomihiko Oda, Nishinomiya (JP)

(21) Appl. No.: 17/946,280

(22) Filed: Sep. 16, 2022

Related U.S. Application Data
(63) Continuation-in-part of application No. PCT/JP2021/007019, filed on Feb. 25, 2021.

(30) Foreign Application Priority Data
Mar. 27, 2020 (JP) 2020-056954

(51) Int. Cl. B63B 49/00; G01C 21/20

(52) U.S. Cl. CPC B63B 49/00; G01C 21/203; B63B 2213/02

(57) ABSTRACT

A navigation information device is provided with a position acquisition unit for acquiring a position information of its own ship, a memory for storing display settings corresponding to a waypoint that is a via point on a planned route, and a display processing unit for performing generation processing for generating a screen in which the position information is superimposed on a chart, and performing change processing for changing display settings to display settings corresponding to the waypoint based on a positional relationship between the position information and the waypoint.

### CROSS-REFERENCE TO RELATED APPLICATION(S)

This application claims priority under 35 U.S.C. § 119 to Japanese Patent Application No. 2020-056954, which was filed on Mar. 27, 2020, the entire disclosure of which is hereby incorporated by reference.

### TECHNICAL FIELD

The present invention relates to navigation information device and navigation information processing methods.

### BACKGROUND

Traditionally, techniques have been developed to generate an appropriate route to a vehicle's destination. For example, JPH07332993A discloses the following navigation device. The navigation device is provided with a current position determination means for determining a self-position by using a Global Positioning System (GPS) means and a dead reckoning navigation means. Then, the navigation device searches a recommended route to a designated destination based on data of a map database, and detects important points such as right/left turn intersections and complicated intersections in the recommended route. At this time, when the current position is close to the important point, the navigation device displays the important point and the current location on the same screen on the map and draws the map with a set scale.

In a voyage of a ship on which a device for displaying an electronic chart on a screen is mounted, a user confirms a peripheral situation, operates a ship, etc., while referring to display information on the screen. The situation in the ship varies from point to point on the navigational route, and excellent technology to assist the navigation of users is desired. The present invention has been made in order to solve the above problems.

### SUMMARY

An object of the present invention is to provide a navigation information device, a navigation information processing method, and a non-transitory computer-readable medium that may provide more effective navigation support. A navigation information device according to an aspect of the present invention is provided with a position acquisition unit for acquiring a position information of its own ship, a memory for storing display settings corresponding to a waypoint which is a via point on a planned route, and a display processing unit for performing generation processing for generating a screen in which position information is superimposed on a nautical chart, and performing change processing for changing display settings to display settings corresponding to the waypoint based on a positional relationship between the position information and the waypoint. The display settings include a setting for switching between at least two or more screens among a Global Positioning System (GPS) plotter device screen, a radar device screen, an automatic steering device screen, and a fish finder screen.

The display settings may include at least one of a position at which the change process is performed, a direction reference on the screen, and a chart displayed when the display is updated with a change in position information, the direction reference of the chart relative to the position information, the scale of the screen, and the ON/OFF of symbol display.

The navigation information device may further include a receptor for receiving an operation of a user. The display processing unit may change the content of the display settings in a memory based on the operation.

The display processing unit may generate the screen in which the positions at which the change processing is performed, are superimposed.

As described above, the present invention registers display settings corresponding to the waypoint in advance in a memory, and changes to display settings according to the positional relationship between the own ship and the waypoint, so that the desired display settings are automatically switched according to the situation of the own ship. As a result, the user may concentrate on the operation of the ship, and may suppress the occurrence of the influence on the work such as a visual observation.

Accordingly, the present invention may effectively support navigation.

### BRIEF DESCRIPTION OF DRAWINGS

FIG. 1 shows a configuration of a navigation information system, according to an embodiment of the present invention;

FIG. 2 shows an example of a navigational route produced by a navigation information device, according to an embodiment of the present invention;

FIG. 3 is a diagram showing an example of a display screen by the navigation information device, according to an embodiment of the present invention;

FIG. 4 is a diagram for explaining an example of the transition of a display screen in the comparative example of the navigation information device, according to the embodiment of the present invention;

FIG. 5 is a diagram for explaining an example of the transition of a display screen in the comparative example of the navigation information device, according to the embodiment of the present invention;

FIG. 6 is a diagram for explaining an example of the transition of a display screen in the comparative example of the navigation information device, according to the embodiment of the present invention;

FIG. 7 is a diagram for explaining an example of the transition of a display screen in the comparative example of the navigation information device, according to the embodiment of the present invention;

FIG. 8 shows an example of a waypoint list screen in the navigation information device, according to an embodiment of the present invention;

FIG. 9 is a diagram showing an example of a flow of display settings registration operations in the navigation information device, according to an embodiment of the present invention;

FIG. 10 is a diagram showing an example of the transition of a display screen in the navigation information device, according to an embodiment of the present invention;

FIG. 11 is a diagram showing another example of display screen transitions in the navigation information device, according to an embodiment of the present invention;

FIG. 12 is a diagram for explaining another example of a display screen transition in the navigation information device, according to an embodiment of the present invention;

FIG. 13 is a diagram for explaining another example of a display screen transition in the navigation information device, according to an embodiment of the present invention;

FIG. 14 is a diagram for explaining another example of a display screen transition in the navigation information device, according to an embodiment of the present invention;

FIG. 15 is a diagram for explaining another example of a display screen transition in the navigation information device, according to an embodiment of the present invention;

FIG. 16 shows an example of a flow of display settings registration operations in a first variation of the navigation information device, according to an embodiment of the present invention;

FIG. 17 shows an example of a flow of display settings registration operations in a second variation of the navigation information device, according to an embodiment of the present invention;

FIG. 18 is a diagram for explaining an example of a display screen in a third variation of the navigation information device, according to an embodiment of the present invention;

FIG. 19 shows an example of a waypoint list screen in a fourth variation of the navigation information device, according to an embodiment of the present invention;

FIG. 20 shows a configuration of the navigation information device in a fifth variation, according to an embodiment of the present invention;

FIG. 21 is a flowchart illustrating an operating procedure when the navigation information device registers display settings of the screen, according to an embodiment of the present invention; and

FIG. 22 is a flowchart illustrating an operating procedure when the navigation information device changes display settings of the screen, according to an embodiment of the present invention.

### DETAILED DESCRIPTION

Embodiments of the present invention will be described below with reference to the drawings. The same reference numerals are given to the same or corresponding parts in the figure, and the description thereof will not be repeated. At least some of the embodiments described below may be arbitrarily combined.

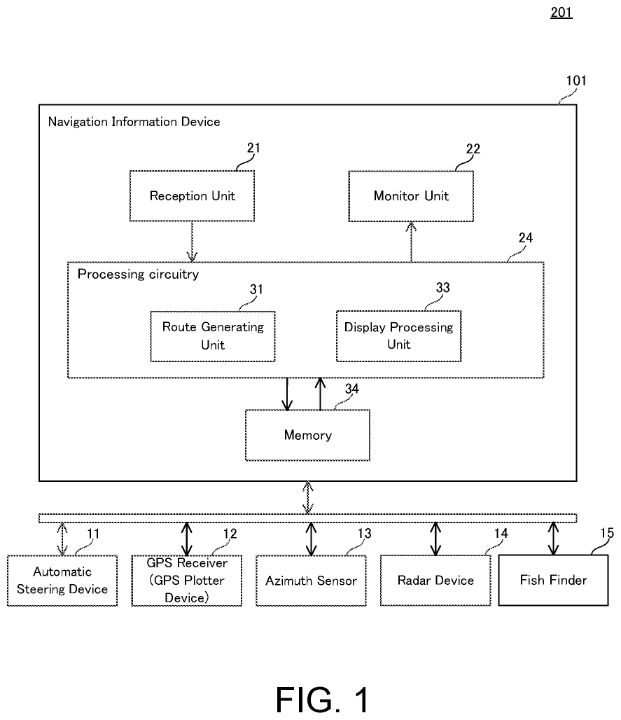

FIG. 1 is a diagram showing a configuration of a navigation information system 201, according to an embodiment of the present invention.

Referring to FIG. 1, the navigation information system 201 includes a navigation information device 101, an automatic steering device 11, a Global Positioning System (GPS) receiver 12, an azimuth sensor 13, and a radar device 14. These devices are mounted on a ship and are connected via a network such as LAN (Local Area Network) or CAN (Controller Area Network) on board.

The navigation information device 101 displays, for example, a navigational route of its own the ship in a monitor 22, which will be described later. The navigation information device 101 is mounted on a steering seat, etc. Further, a user may visually and easily grasp navigational route of his/her own ship by confirming a screen displayed on the monitor 22.

The navigation information device 101 receives an instruction of automatic navigation from the user and transmits instruction information showing instruction contents to the automatic steering device 11. The instruction information includes, for example, navigation route information indicating a navigational route.

The user may confirm the information on the screen displayed on the monitor 22, and may operate a rudder, set the automatic steering device 11, or the like so that the ship is navigated in accordance with the navigational route.

The GPS receiver 12 receives a positioning signal from a GPS antenna (not shown) fixed to the ship, detects current position of the ship, and transmits a position information indicating the detected position of the ship to the navigation information device 101 and the automatic steering device 11. A device that provides its own ship position on a chart based on the information of the GPS receiver 12 is also called a GPS plotter device. The GPS plotter device 12 may be directly connected to a memory 34 having the chart.

The azimuth sensor 13 measures the bow azimuth of a ship based on a relative relationship among a plurality of positions of the ship where a plurality of GPS antennas device (not shown) fixed to the ship are detected, and transmits bow azimuth information indicating the measured bow azimuth to the navigation information device 101 and the automatic steering device 11.

The automatic steering device 11 automatically operates the rudder so that its own ship navigates in accordance with the navigational route.

The radar device 14 transmits and receives radio waves via a radar antenna (not shown). Then, the radar device 14 generates a radar image showing the state of a target such as another ship located around its own ship, and transmits information of the radar image to the navigation information device 101. The navigation information device 101 uses the received video information to display the position of a target located around its own ship on a chart displayed on the monitor 22.

The navigation information system 201 includes the automatic steering device 11, the GPS receiver 12, the azimuth sensor 13, and the radar device 14. The navigation information system 201 may further include an Automatic Identification System (AIS) for automatically identifying other ship, a fish finder 15, and a device such as a terminal device. The navigation information system 201 is not limited to a configuration including all of the automatic steering device 11, the GPS receiver 12, the azimuth sensor 13, and the radar device 14.

As shown in FIG. 1, the navigation information device 101 includes a receptor 21, the monitor 22, and an information processing unit 24 (processing circuitry). The information processing unit 24 includes a route generating unit 31 and a display processing unit 33. The memory 34 is, for example, a non-volatile memory. It should be noted that the monitor 22 and the memory 34 may be outside the navigation information device 101.

The route generating unit 31 acquires position information of its own ship as a position acquisition part. More specifically, the route generating unit 31 receives its ship position information from the GPS receiver 12.

The display processing unit 33 displays a chart showing an area within a predetermined range from a current position of its own ship on the monitor 22.

The receptor 21 receives the user's operation on the screen of the monitor 22 and outputs an operation information indicating the contents of the operation to the information processing unit 24.

The navigation information device 101 generates the navigational route by using various information set by the user.

For example, when the user performs route planning, it is assumed that the user performs an operation to designate an arbitrary point on the chart displayed on the monitor 22 as the destination D. In this case, the receptor 21 outputs position information indicating the position of the destination D designated by the user as an operation information to the information processing unit 24.

When a user performs an operation for respectively designating the positions of one or more waypoints, i.e., turning points, in a chart displayed on the monitor 22, the receptor 21 outputs a position information indicating the positions of the waypoints designated by the user as an operation information to the information processing unit 24.

The display processing unit 33 in the information processing unit 24 stores position information of destination D received from the receptor 21 and position information of each waypoint, in the memory 34.

The route generating unit 31 in the information processing unit 24 generates a navigational route connecting each waypoint and the destination D based on position information of the destination D and position information of each waypoint stored in the memory 34. The route generating unit 31 outputs the generated navigational route or navigation route information showing information about planned route to the display processing unit 33 and stores it in the memory 34.

Specifically, the memory 34 stores setting information related to chart information DB (Data Base) and its own ship. In the chart information DB, the depth of each location is preserved. The setting information includes the size of the own ship, etc.

The route generating unit 31 generates a navigation route information based on position information, heading information, the chart information DB, and setting information of its own ship.

The display processing unit 33 performs processing for displaying navigational route displayed by navigation route information generated by the route generating unit 31 on the monitor 22. The display processing unit 33, in accordance with display settings of the memory 34, performs processing for displaying on the monitor 22 a screen in which current position, navigational route and the like of its own ship are superimposed on a nautical chart.

It should be noted that the user may select a navigational route from one or more routes through which the user's own ship has passed in the past.

For example, based on position information of its own ship received from the GPS receiver 12, the route generating unit 31 stores a past route to the memory 34 which is navigational route through which its own ship has passed in the past. When the display processing unit 33 receives an operation information indicating an operation for instructing a user to display setting screen of navigational route, from the receptor 21, the display processing unit 33 performs processing for displaying one or more wake routes stored in the memory 34, on the monitor 22.

When the user designates any one of the past route or a plurality of past routes displayed on the monitor 22, the receptor 21 outputs the designated route to the route generating unit 31. Then, the route generating unit 31 outputs a navigational route indicating the past route to the display processing unit 33.

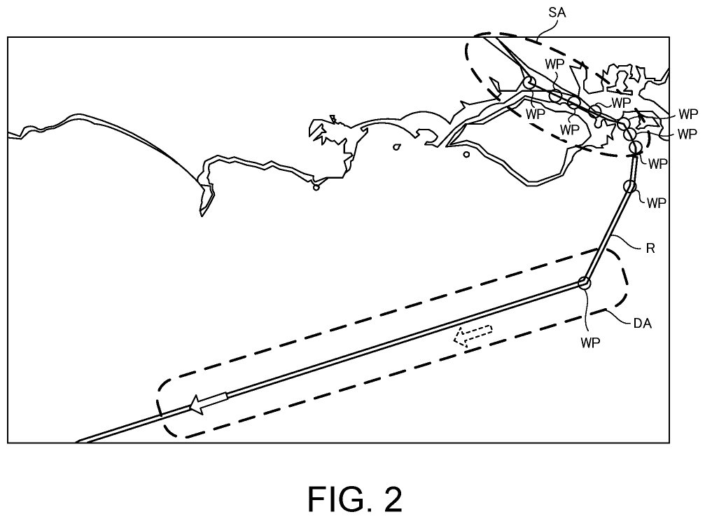

FIG. 2 is a diagram showing an example of the navigational route generated by the navigation information device 101, according to an embodiment of the present invention.

Referring to FIG. 2, in a navigational route R, area SA in the vicinity of a port or a shallow water tends to have a lot of obstacles and a waypoint WP becomes dense. On the other hand, in area, such as Oceania, the number of municipalities in obstacles is small and the number of waypoint WPs tends to decrease.

The user performs route planning and creates the navigational route R, and then displays the navigational route R on the screen of the monitor 22 to monitor the route.

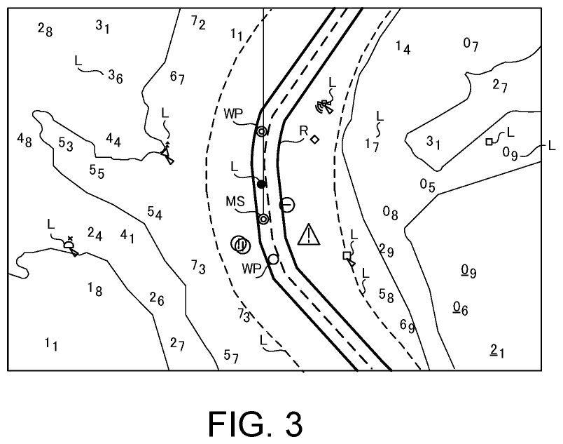

FIG. 3 is a diagram showing an example of a display screen by the navigation information device 101, according to an embodiment of the present invention. FIG. 3 shows area SA, a shallow sea area.

Referring to FIG. 3, in addition to navigational route R and the waypoint WP, the screen displays, for example, a symbol MS indicating the position of the own ship and a symbol L indicating an object or peripheral information existing around the own ship.

Here, the chart information DB in the memory 34 has information of symbols such as letters, marks or lines that serve as landmarks for navigation.

Specifically, the chart information DB has symbol information indicating, for example, place names, special marks, light beacons, light buoys, buoys, contour lines, tidal currents, fishing reefs, obstacles, obstacles under Safety area, fishing gear, sediment, water quality, warning areas, light arcs, mountain tops, topography, foghorn signals, radio stations, services, and harbor facilities. Such symbol information is registered in the chart information DB in advance.

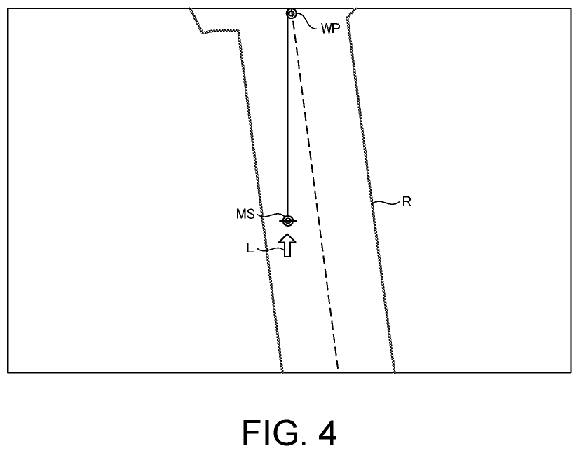

FIGS. 4 to 7 are diagrams for explaining an example of transition of a display screen in the comparative example of the navigation information device 101, according to the embodiment of the present invention.

Referring to FIGS. 4 to 7, during route monitoring, the user changes display settings on the screen according to the situation of the own ship.

More specifically, the ship moves from area SA shown in FIG. 3 to area DA, which is a deep sea area, and the monitor 22 displays the screen shown in FIG. 4.

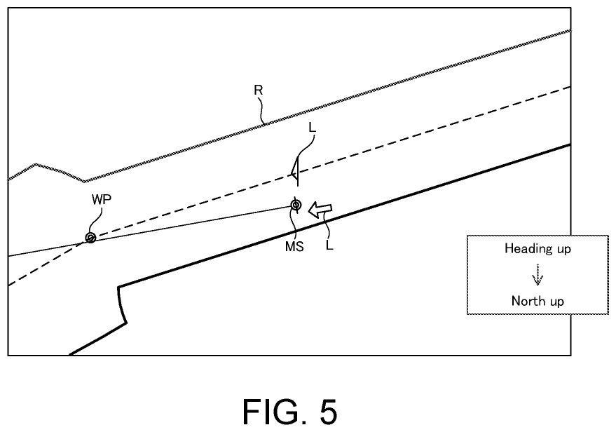

Since the screen shown in FIG. 4 is difficult to see, the user changes the azimuth mode, which is one of display settings, as shown in FIG. 5. Specifically, the user changes the reference of the orientation on the screen from a reference (Heading Up) in which the traveling direction of the user's ship is the direction to an upper side of the screen to a reference (North Up) in which the north is the direction to the upper side of the screen.

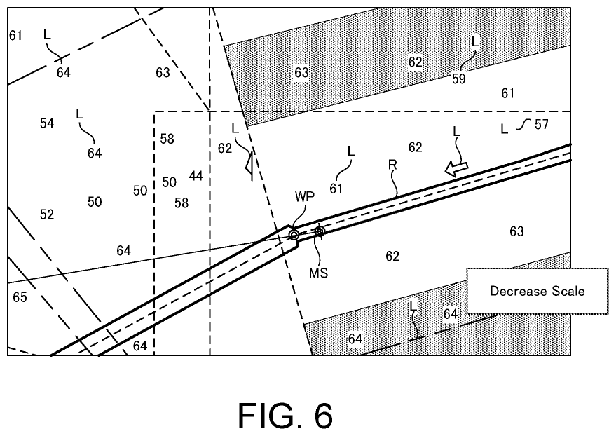

Next, the user operates a wheel of a mouse to reduce the scale, which is an example of the display settings, as shown in FIG. 6.

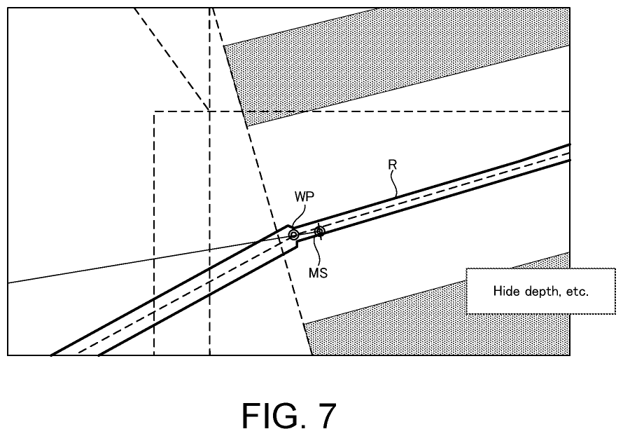

Next, as shown in FIG. 7, the user changes ON/OFF of the display for each symbol type, which is an example of the display settings. In this example, the user has set depth symbol L, the linear symbol L, and the like to be hidden. The setting of ON/OFF of the display may be performed individually by the user manually or in accordance with the selection of information registered in a profile of the user.

In FIGS. 4-7, the user must manually change the orientation mode, scale, symbol display ON/OFF, etc. Therefore, since it takes a long time to change the display settings to the desired one, there is a possibility that confirmation of the surrounding conditions of the ship and influence on the operation of the ship during the setting operation.

In the navigation information device 101, according to the embodiment of the present invention, the above-mentioned problems are solved by the following structure and operation.

Referring again to FIG. 1, the memory 34 stores display settings corresponding to a waypoint that is a via point on a planned route.

The display processing unit 33 performs processing for displaying a screen superimposed on position information of its own ship on the chart. Based on a positional relationship between the position information and the waypoint, the display processing unit 33 performs a change process of changing display settings of the screen to display settings corresponding to the waypoint.

For example, display settings include at least one of display settings switching point, absolute bearing setting, relative display settings, screen scale, and ON/OFF of symbol display.

It should be noted that display settings switching point is a point where a change to display settings should be made and is a point before the waypoint in a planned route. The absolute bearing setting is a setting in which a specific bearing becomes the upper part of the screen when the chart displayed on the screen is updated by a change in the position of the own ship. The relative display settings are settings for selecting a display in which the own ship is fixed in the center of the screen or a display in which the area of the map is fixed.

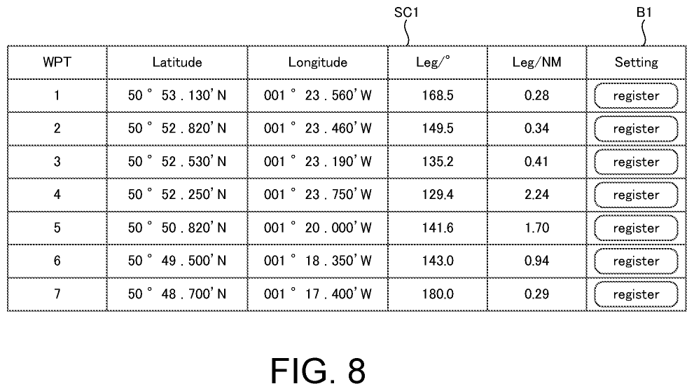

FIG. 8 is a diagram showing an example of a list screen of waypoints in the navigation information device 101, according to an embodiment of the present invention.

Referring to FIG. 8, the display processing unit 33 performs processing for displaying the waypoint list screen SC1 on the monitor 22 based on the navigation route information received from the route generating unit 31.

The waypoint list screen SC1 displays the position of each waypoint in the navigational route, the direction of the route to the next waypoint, the length of the route, and a button B1.

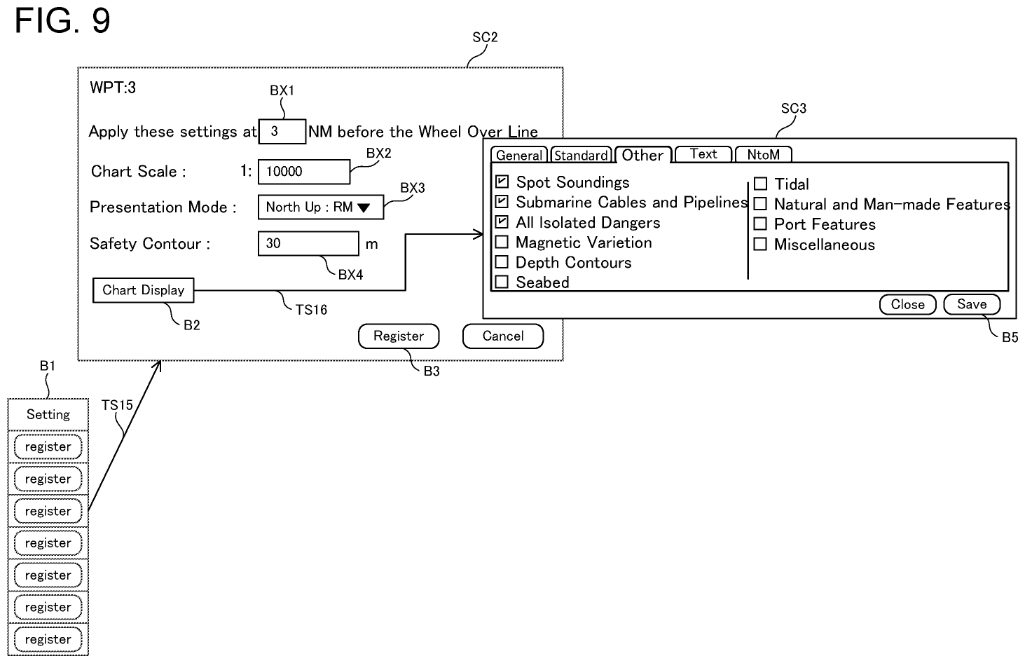

FIG. 9 is a diagram showing an example of a flow of registration work of display settings in the navigation information device 101, according to an embodiment of the present invention.

Referring to FIG. 9, when the user presses the button B1 on the waypoint list screen SC1, the display processing unit 33 displays individual setting screen SC2 of the waypoint (transition TS15).

In individual setting screen SC2, the user may set setting changeover point, the screen scale, absolute bearing setting, the relative screen setting, and the depth of the safety contour by inputting or selecting values or the like in boxes BX1-BX4.

In the example of FIG. 9, the switchover of the waypoint 3 to the display settings is performed at a point 3 nautical miles before (3 NM before) the position (Wheel Over Line) to be steered to the waypoint 3. The display settings, in this example, have a chart scale of 1:10,000, a North Up orientation reference of absolute bearing setting, a Presentation Mode in which relative display settings change the display while placing its RM, that is, its own ship in the center of the screen, and a safety contour of 30 m.

Next, when the user presses the button B2 in the individual setting screen SC2, the display processing unit 33 displays setting screen SC3 for ON/OFF of a symbol display (transition TS16).

In the setting screen SC3, the user may set ON/OFF of display of symbols such as depth contours by selecting a check box.

When the user presses the button B5 in the setting screen SC3, the display processing unit 33 retains the state of each checkpoint and displays individual setting screen SC2 again. When the user presses the button B3 in the individual setting screen SC2, the display processing unit 33 stores display settings of the waypoint 3 based on the operation of the user in the memory 34.

In an example, the car navigation system device displays an enlarged map in the vicinity of road intersections, but the navigation information device 101 may register optimum display settings in advance for each waypoint in consideration of the position of each waypoint set by the user, and thereby may realize automatic switching to a screen whose content such as visibility is greatly improved in route monitoring.

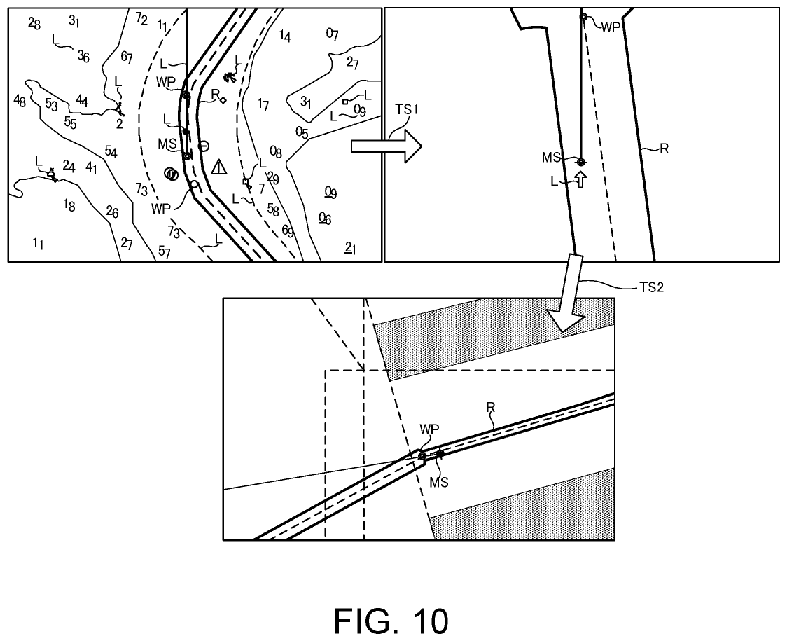

FIG. 10 is a diagram showing an example of the transition of the display screen in the navigation information device 101, according to an embodiment of the present invention.

Referring to FIG. 10, when the own ship reaches setting changeover point during route monitoring, the display processing unit 33 changes display settings on the screen.

When the ship moves from area SA to area DA, which is a deep sea area, the screen displays the same screen as in FIG. 4 (transition TS1). When the own ship reaches the setting changeover point, the azimuth mode is changed to North Up, the scale is reduced, and a screen similar to that shown in FIG. 7 in which depth symbol L, the linear symbol L, and the like are changed to non-display is displayed (transition TS2).

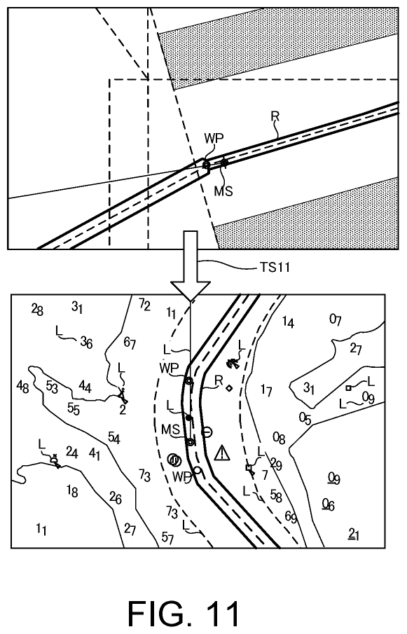

FIG. 11 is a diagram showing another example of the transition of the display screen in the navigation information device 101, according to the embodiment of the present invention.

In FIG. 11, when the ship moves from area DA to area SA, which is a shallow sea area, and ship reaches setting changeover point, the azimuth mode is changed to Heading Up, and the scale is increased. The depth symbol L and the linear symbol L are displayed in the same manner as in FIG. 3 (transition TS11).

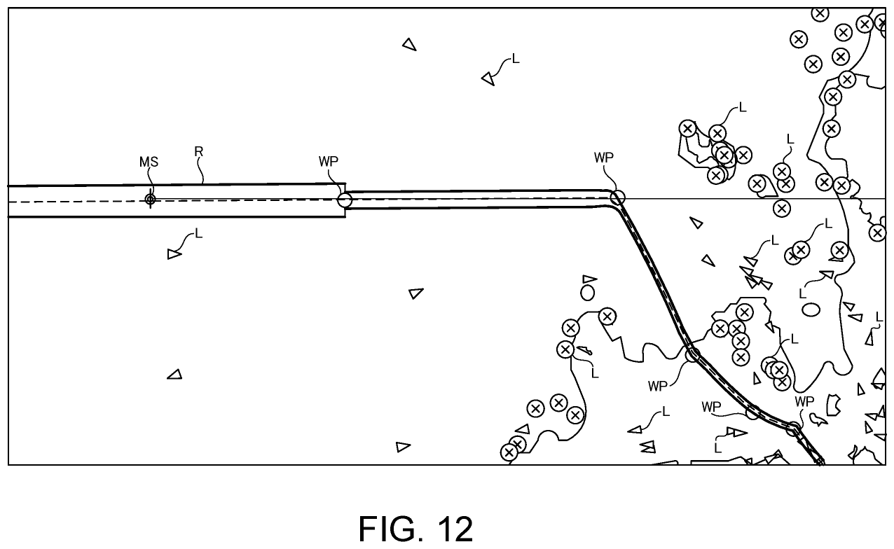

FIGS. 12 to 14 are diagrams for explaining another example of a display screen transition in the navigation information device 101, according to an embodiment of the present invention.

The display processing unit 33 performs processing for displaying a screen including a symbol L indicating an object detected by the radar device 14 and a sea chart around its own ship on the basis of chart information DB and a radar information.

It should be noted that the display processing unit 33 may be configured to perform processing for displaying a screen based on Automatic Identification System (AIS) information from the AIS mounted on its own ship in addition to radar information. In this case, based on the radar information and the AIS information, the display processing unit 33 performs processing to display a screen including a symbol L indicating the object detected by the radar device 14 and a symbol indicating the position of the other ship existing around the own ship which is the source of the AIS information.

The display processing unit 33 may be configured to perform processing for displaying a screen based on the AIS information and chart information DB without using radar information.

Referring to FIG. 12, the display processing unit 33 displays a large scale screen in area DA, which is a deep sea area. In the vicinity of the own ship located on a left side of the screen, there are few other ship symbols L represented by triangles, so that there is no problem in navigation even in a large scale.

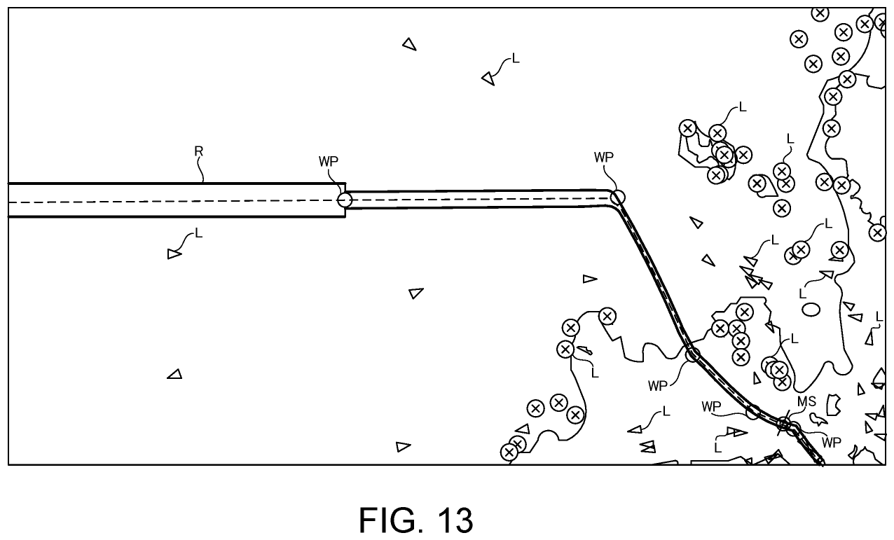

Referring to FIG. 13, when the user enters area SA, which is a shallow sea area at the lower right of the screen, while a large scale screen is displayed by moving the own ship, a situation occurs in which a large number of other ship exist in the vicinity of the own ship. In such a situation, the scale should be changed to a small value in order to monitor the vicinity of its own ship more closely.

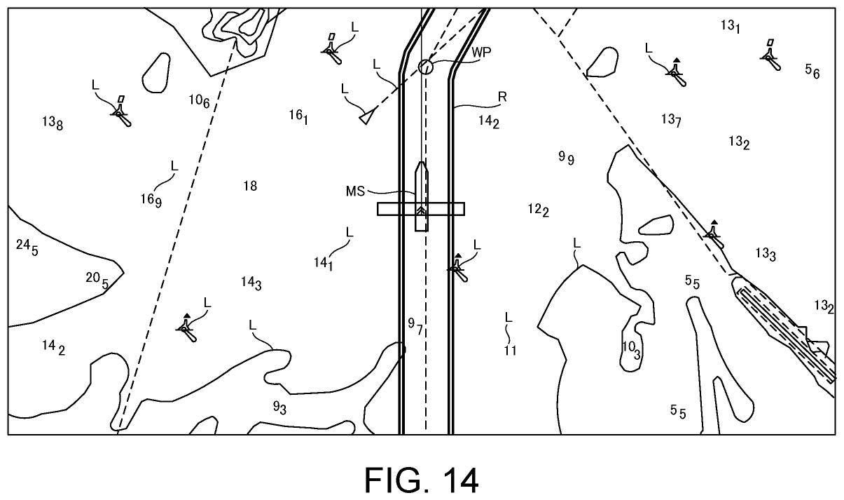

Referring to FIG. 14, the display processing unit 33 displays a screen with the heading as north by reducing the screen scale and changing the heading reference to North Up. On this screen, it is possible to easily recognize that other ship exists at the top of the screen and is about to cross the route of the own ship. On this screen, a green chain line along the travel direction of the other ship is displayed in order to make it easy to understand the travel direction of the other ship.

As a result of the above processing, unlike on land for a road having a lane, especially when there are a large number of other ships around the own ship, display settings of the scale or the like is automatically switched for each waypoint. Therefore, the present invention provides more effective navigation support.

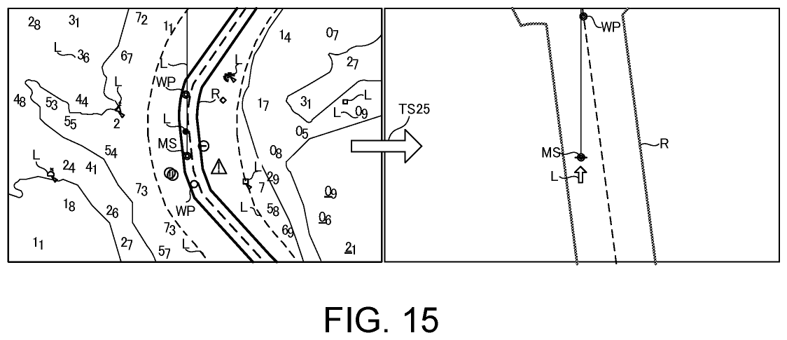

FIG. 15 is a diagram for explaining another example of a display screen transition in the navigation information device 101, according to an embodiment of the present invention.

Referring to FIG. 15, the display processing unit 33 continues to display the previous display settings for waypoints where the display settings is not registered with the memory 34.

When the user's ship is moved from area SA to area DA, the same display settings screen as in FIG. 4 is continuously displayed (transition TS25).

That is, in the navigation information device 101, it is not necessary that all waypoints in the navigational route have registered display settings.

### First Variation

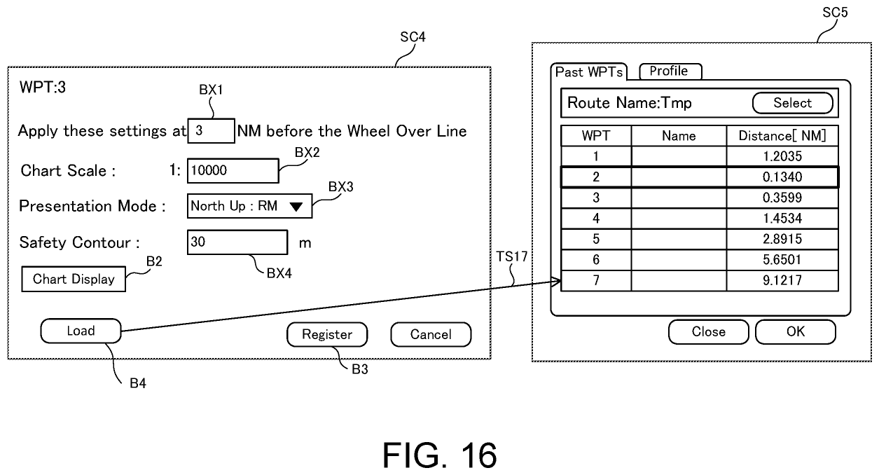

FIG. 16 is a diagram showing an example of a flow of a registration work of display settings in a first variation of the navigation information device 101, according to an embodiment of the present invention.

The memory 34 further stores the location of the waypoint in a planned route in the past and historical information of display settings corresponding to the location.

In the change processing, the display processing unit 33 selects display settings included in historical information and makes the change to the selected display settings.

Referring to FIG. 16, when the user presses the button B1 on the list screen SC1 shown in FIG. 8, the display processing unit 33 performs a process of displaying, on the monitor 22, an individual setting screen SC4 to which the button B4 is added in comparison with individual setting screen SC2 of the waypoint.

When the user presses the button B4 in the individual setting screen SC4, the display processing unit 33 refers to historical information stored in the memory 34 and displays a list screen SC5 of each waypoint (hereinafter also called registered waypoint) registered in the past.

The distance of each registered waypoint from the waypoint 3 in the individual setting screen SC4 is displayed on the list screen SC5. Thereafter, the user selects registered waypoint 2 closest to the waypoint 3 on the list screen SC5.

The display processing unit 33 acquires display settings of the selected registered waypoint 2 from the memory 34 according to the operation of the user and stores it in the memory 34 as display settings of the waypoint 3.

Alternatively, when the user selects a profile tab on the list screen SC5, the display processing unit 33 displays a list screen of profiles (not shown). The display processing unit 33 acquires display settings registered in the profile selected by the user on the list screen SC5 from the memory 34 and stores it in the memory 34 as display settings of the waypoint 3.

The display processing unit 33 may change the content of the display settings in the memory 34 in accordance with the user's operations, as described above.

### Second Variation

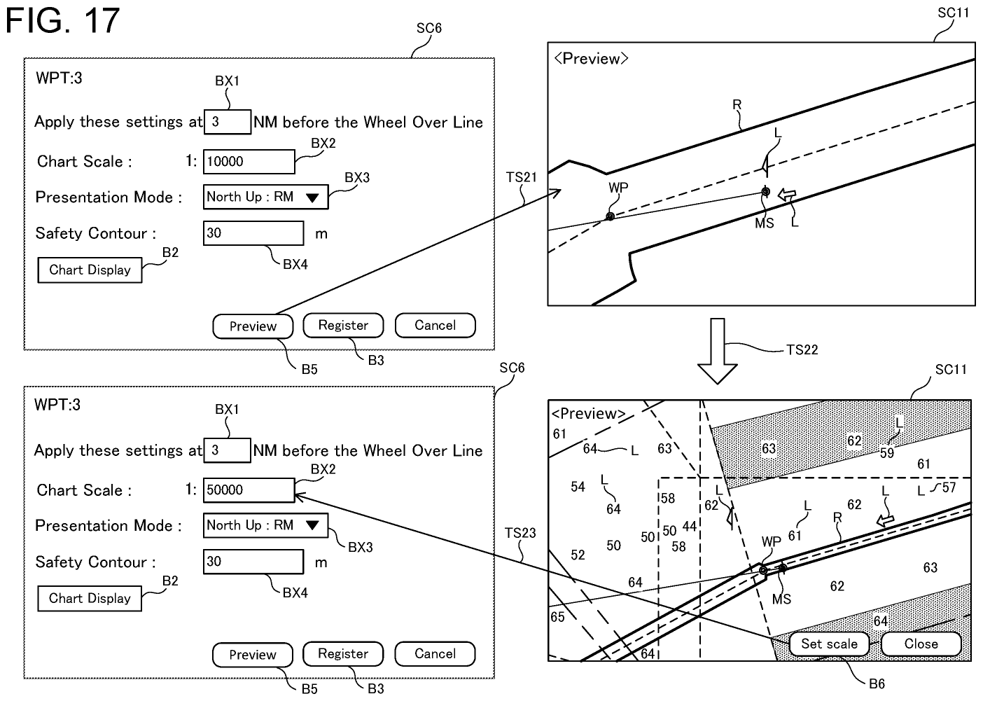

FIG. 17 is a diagram showing an example of the flow of display setting's registration work in a second variation of the navigation information device 101, according to an embodiment of the present invention.

Referring to FIG. 17, when the user presses the button B1 on the list screen SC1 shown in FIG. 8, the display processing unit 33 performs a process of displaying, on the monitor 22, individual setting screen SC6 to which a button B5 is added in comparison with individual setting screen SC2 of the waypoint.

When the user presses the button B5 in the individual setting screen SC6, the display processing unit 33 displays a preview screen SC11 (transition TS21).

The preview screen SC11 displays the situation around the waypoint 3 based on the current display settings. Thereafter, the user reduces the scale of the preview screen SC11 by operating a wheel of the mouse (transition TS22).

When the user depresses a button B6 on the preview screen SC11 having the reduced scale, the display processing unit 33 displays the individual setting screen SC6 reflecting the current display settings of the preview screen SC11 (transition TS23).

In the example of FIG. 17, the scale of the waypoint 3 is changed from 1:10,000 to 1:50,000 by the user's operation on the preview screen SC11.

Thus, the display processing unit 33 may change the content of display settings in the memory 34 according to the user's operation, as described above.

### Third Variation

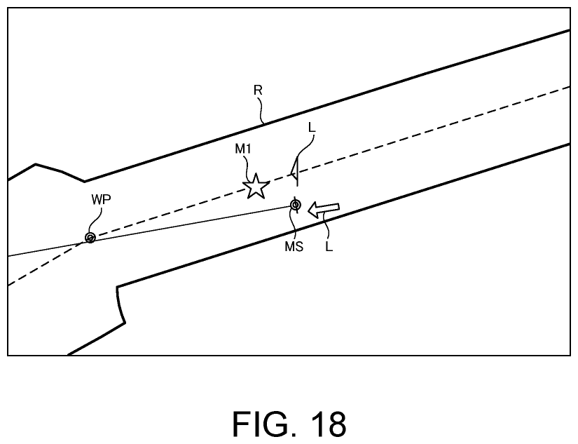

FIG. 18 is a diagram for explaining an example of the display screen in a third variation of the navigation information device 101, according to an embodiment of the present invention.

Referring to FIG. 18, the display processing unit 33 generates a screen superimposing a position in front of the waypoint in a planned route at which a change to display settings corresponding to the waypoint should be made.

As an example, the display processing unit 33 displays a screen in which a symbol M1 of setting changeover point is added on a navigational route R in the screen shown in FIG. 5.

### Fourth Variation

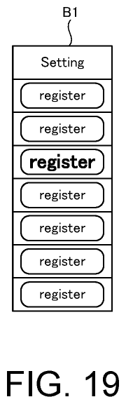

FIG. 19 is a diagram showing an example of a list screen of waypoints in a fourth variation of the navigation information device 101, according to an embodiment of the present invention.

Referring to FIG. 19, the display processing unit 33 recognizably displays the registered waypoints of display settings on the waypoint list screen SC1. In the example of FIG. 19, the display processing unit 33 displays the characters of the button B1 corresponding to the waypoint 3 which is the registered waypoint in a thicker color than the other waypoints. It should be noted that the display processing unit 33 may change the character color between the registered and unregistered waypoints.

### Fifth Variation

The navigation information device 101 provides, but is not limited to, that users register their display settings for each waypoint in the route planning and the display settings is automatically switched. The navigation information device 101 may be configured to automatically register the display settings of each waypoint in the route planning.

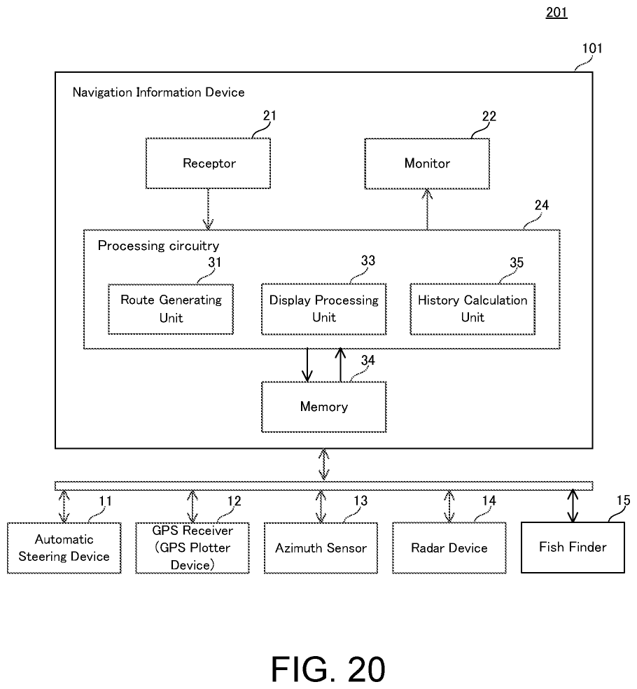

FIG. 20 is a diagram showing a configuration of the fifth variation of the navigation information device 101, according to an embodiment of the present invention.

Referring to FIG. 20, in the fifth variation of the navigation information device 101, the information processing unit 24 further includes a history calculation unit 35 as compared to the navigation information device 101 shown in FIG. 1.

The memory 34 stores the location of each waypoint in the navigational route in the past, display settings corresponding to the location, and historical information indicating the status of the waypoint. The historical information is the time zone, weather conditions, and tidal currents when the ship passes through the waypoint, the location of the waypoint, and the shortest distance from the waypoint to land, etc.

It should be noted that the above state may be a measurement result of various sensors in the navigation information system 201.

When a position information of the waypoint (hereinafter also called target waypoint) is stored in the memory 34, the history calculation unit 35 calculates the similarity of the situation between target waypoint and each waypoint in historical information stored in the memory 34, according to a predetermined arithmetic expression. Then, the history calculation unit 35 selects display settings of the waypoint having the highest similarity among the waypoints in the historical information and stores it in the memory 34 as display settings of the target waypoint.

That is, in the change processing, the display processing unit 33 selects display settings included in the historical information and changes it to the selected display settings.

Instead of using a predetermined arithmetic expression, the history calculation unit 35 may be configured to perform machine learning using the position of the waypoint and display settings corresponding to the position as learning parameters to create a classification model.

In this case, the memory 34 stores display settings calculated by the classification model based on the position of the waypoint. That is, in the variation process, the display processing unit 33 changes to display settings based on the classification model and the location of the waypoint.

The configuration is not limited to the configuration in which the historical information is stored in the memory 34, but may also be a configuration in which historical information is stored in a server (not shown) or the like, and the history calculation unit 35 acquires historical information from the server via a network to create a classification model.

The learning parameter may further include at least one of ship speed, depth, direction, time, weather, catch, hazard, congestion, and solar radiation corresponding to the waypoint.

### Sixth Variation

The display settings include a setting for mutually switching a screen of a radar device 14, an automatic steering device 11, a GPS plotter device 12 (chart information and its own ship position), and the fish finder 15. That is, when the predetermined condition is satisfied, the displayed screen is automatically switched to the screen of device registered in advance. The condition may be a relationship between the location of the waypoint and the location of ship, or it may be a condition of the surrounding environment or its own ship. The surrounding environment includes time of day, depth, weather, solar radiation, hazard, temperature, and ship density. The conditions of the ship may include ship speed, heading, catch and engine conditions.

Further, a fishing point is registered as the waypoint in advance, and when the ship arrives at the waypoint or before arrives at the waypoint, the screen of the chart outputted from the chart information DB may be switched to the screen of the fish finder 15. It is also possible to automatically switch to the automatic steering device 11 screen when or after the ship leaves from the fishing point.

When a congested sea area with many other ship is registered for a specific waypoint and when the ship approaches the waypoint, the screen of the chart output from the chart information DB may be automatically switched to the screen of the radar device 14.

If the ship gets close to a specific waypoint while the ship's engine is running at a warmer than normal temperature, then it may switch to the automatic steering device's 11 engine status screen. The waypoint acts as a reference location for ship health monitoring and triggers screen changes in the ship and positional relationship.

The waypoint is not a point indicating a specific location, but may be an area having a certain range.

The navigation information device 101 includes a computer, and an arithmetic processing unit such as a Central Processing Unit (CPU) in the computer reads a program including part or all of the steps of the flowchart below from the memory 34 and executes the program. This program may be installed from outside such as a server or from a distributed program stored in a recording medium.

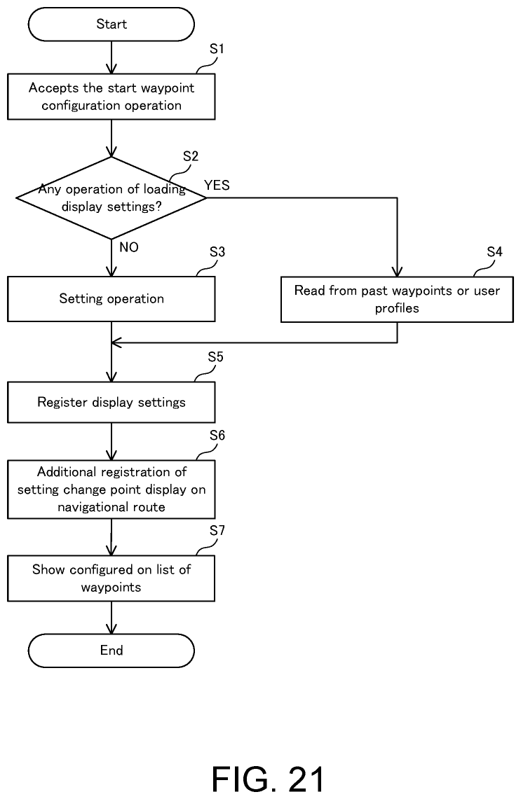

FIG. 21 is a flowchart showing an operating procedure when the navigation information device 101 registers display settings of the screen, according to the embodiment of the present invention.

Referring to FIG. 21, at first, the navigation information device 101 receives a waypoint setting start operation by a route planning user and a depressing operation of the button B1 on the waypoint list screen SC1 (step S1).

When the user display settings presses the button B4 in the individual setting screen SC4 (YES in step S2), the navigation information device 101 reads display settings of registered waypoint selected by the user or display settings registered in the profile from the memory 34 (step S4) and registers display settings as display settings of the corresponding waypoint in the memory 34 (step S5).

Alternatively, the navigation information device 101 receives the user's setting operation in the individual setting screen SC2 and setting screen SC3 (NO in step S2 and step S3), and registers display settings based on the setting operation in the memory 34 (step S5).

Further, the navigation information device 101 additionally registers the display of the symbol M1 of setting changeover point in the display settings of the memory 34 (step S6).

Further, the navigation information device 101 displays the registered waypoint of the display settings on the waypoint list screen SC1 so as to be recognizable (step S7).

The operations of steps S2 and S4 correspond to the first variation, the operation of step S6 corresponds to the third variation, and the operation of step S7 corresponds to the fourth variation. That is, the navigation information device 101 may be configured such that some or all of the operations of steps S2 and S4, the operation of step S6, and the operation of step S7 are not performed.

In step S5, the navigation information device 101 may display the preview screen of the second variation and change display settings.

The navigation information device 101 may perform the processing shown in FIG. 21 either when the display settings is newly registered or when the registered display settings is changed.

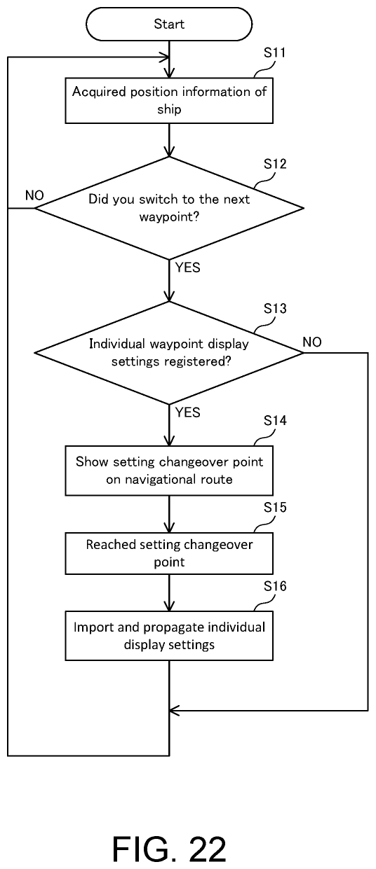

FIG. 22 is a flowchart defining operating procedure when the navigation information device 101 changes display settings of the screen, according to an embodiment of the present invention.

Referring to FIG. 22, after the departure of the own ship, the navigation information device 101 continuously acquires position information of the own ship until the own ship is switched to the route to the next waypoint (NO in step S12) (step S11).

Further, when the own ship is switched to the route to the next waypoint (YES in step S12) and the individual display settings of the next waypoint has been registered (YES in step S13), the navigation information device 101 displays the symbol M1 of setting changeover point on navigational route on the screen (step S14).

Further, the navigation information device 101 continuously acquires position information of the own ship, and when the own ship reaches the set switching point (step S15), the navigation information device 101 read display settings corresponding to the point from the memory 34, and performs change processing to change display settings of the screen to the read display settings (step S16).

On the other hand, when an individual display settings of the next waypoint is not registered (NO in step S13), the navigation information device 101 maintains the current display settings and continuously acquires position information of its own ship until its own ship is switched to a route to a new waypoint (NO in step S12) (step S11).

It should be noted that the operation in step S14 corresponds to the third variation, and the navigation information device 101 may have a configuration in which the operation in step S14 is not performed.

Supplementary information—The situation in the ship varies from point to point on the navigational route, and it is desirable to have excellent technology to assist users in navigation.

In the navigation information device 101, according to the embodiment of the present invention, the route generating unit 31 acquires position information of its own ship. The memory 34 remembers display settings corresponding to the waypoint which is via point on a planned route. Then, the display processing unit 33 performs processing for displaying a screen in which position information of its own ship is superimposed on the chart, and performs processing for changing display settings of the screen to display settings corresponding to the waypoint based on a positional relationship between the position information and the waypoint.

Further, in the navigation information processing method according to the embodiment of the present invention, display settings corresponding to a waypoint which is a via point on a planned route is stored, a position information of the own ship is acquired, a screen superimposed with a position information of the own ship on a nautical chart is displayed, and a change process for changing display settings of the screen to display settings corresponding to the waypoint is performed based on positional relationship between the position information and the waypoint.

Although the type, amount, and accuracy of information required vary depending on the conditions of navigation in the ocean, in the bay, etc., the user may navigate while switching the desired display settings for each waypoint in accordance with the conditions of the user's own ship by registering display settings corresponding to the waypoint in advance in the memory 34 and changing to display settings according to positional relationship between the user's own ship and the waypoint. The configuration in which the display settings is switched according to the movement of the own ship enables the user to concentrate on the operation of the ship and to suppress the occurrence of an influence on operations such as visual observation.

Therefore, the navigation information device 101 and the navigation information processing method according to the embodiment of the present invention may provide more effective navigation support.

In the navigation information device 101 according to the embodiment of the present invention, the display settings include at least one of a position at which a change processing is performed, a reference of a direction on a screen, a chart displayed when the display is updated in accordance with a change of position information of the own ship, a reference of a position of the chart relative to position information, a scale of the screen, and ON/OFF of a symbol display.

By such configuration in which various kinds of display settings may be changed, automatic switching of display settings may be realized more effectively. With a configuration in which the set switching point may be changed for each waypoint, the switching timing of the display settings may be changed according to the density of the waypoint or display settings may be switched at a specific position before the steering position according to the ON/OFF of a mark such as a lighthouse. In addition, by the constitution in which the scale of the screen may be changed for each waypoint, the scale may be changed in accordance with the density of the waypoint or the scale may be set to a specific value in accordance with the existence of a mark such as a lighthouse.

In the navigation information device 101, according to the embodiment of the present invention, the receptor 21 receives a user's operation. The display processing unit 33 then changes the content of display settings in the memory 34, in accordance with the operation.

With such configuration, it is possible to provide display settings of more appropriate content for each waypoint by using the display settings determined by the user while referring to the preview screen.

In the navigation information device 101, according to the embodiment of the present invention, the display processing unit 33 generates a screen in which the position where the change processing is performed, are superimposed.

With such configuration, the user may easily grasp the timing at which display settings are switched, thereby improving the convenience of the user.

In the navigation information device 101, according to the embodiment of the present invention, the memory 34 further stores the location of the waypoint in a planned route in the past and historical information of the display settings corresponding to the location. In the change processing, the display processing unit 33 selects display settings included in the historical information and changes it to the selected display settings.

With such configuration, it is possible to easily realize display settings having appropriate content for each waypoint by using the display settings registered in the past.

In the navigation information device 101, according to the embodiment of the present invention, the history calculation unit 35 performs machine learning using the position of the waypoint and display settings corresponding to the position as learning parameters to create a classification model. The memory 34 stores display settings calculated by the classification model based on the position of the waypoint.

With such configuration, it is possible to realize display settings of appropriate content based on the past history for each waypoint.

In the navigation information device 101, according to the embodiment of the present invention, the learning parameter further includes at least one of a displayed device (the fish finder 15, the radar device 14, the automatic steering device 11, the GPS plotter device 12), ship speed, depth, direction, time, weather, and solar radiation when the ship passes through the waypoint.

With such configuration, the parameters regarding the ship useful for machine learning, may be further used to provide more appropriate display settings.

The above embodiments are exemplary in all respects and are not restrictive. The scope of the invention is set forth in the claims, not in the above description, and includes the meaning of and all variations within the scope of the claims.

### Terminology

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiment disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface.” The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, movable, fixed, adjustable, and/or releasable connections or attachments. The connections/attachments can include direct connections and/or connections having intermediate structure between the two components discussed.

Unless otherwise explicitly stated, numbers preceded by a term such as “approximately,” “about,” and “substantially” as used herein include the recited numbers, and also represent an amount close to the stated amount that still performs a desired function or achieves a desired result. For example, unless otherwise explicitly stated, the terms “approximately,” “about,” and “substantially” may refer to an amount that is within less than 10% of the stated amount. Features of embodiments disclosed herein preceded by a term such as “approximately,” “about,” and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A navigation information device, comprising:
a memory storing display settings corresponding to a waypoint which is a via point on a planned route; and
processing circuitry configured to:
acquire position information of an own ship, and
perform a change process to change to display settings corresponding to the waypoint based on a positional relationship between the position information and the waypoint, wherein the display settings include a setting for switching between at least two screens among a Global Positioning System (GPS) plotter device screen, a radar device screen, an automatic steering device screen, and a fish finder screen.

2. The navigation information device of claim 1, wherein the display settings include at least one of a position at which the change process is performed, a direction reference on the screen, and a chart displayed when the display is updated with a change in one of the position information, the direction reference of the chart relative to the position information, a scale of the screen, and an ON/OFF of symbol display.

3. The navigation information device of claim 1, further comprising a receptor for receiving an operation of a user, wherein
the processing circuitry is further configured to change content of the display settings in the memory based on the operation.

4. The navigation information device of claim 2, further comprising a receptor for receiving an operation of a user, wherein
the processing circuitry is further configured to change content of the display settings in the memory based on the operation.

5. The navigation information device of claim 1, wherein the processing circuitry is further configured to generate a screen in which a position at which the change process is performed is superimposed.

6. The navigation information device of claim 2, wherein the processing circuitry is further configured to generate a screen in which a position at which the change process is performed is superimposed.

7. The navigation information device of claim 3, wherein the processing circuitry is further configured to generate a screen in which a position at which the change process is performed is superimposed.

8. The navigation information device of claim 4, wherein the processing circuitry is further configured to generate a screen in which a position at which the change processing is performed is superimposed.

9. The navigation information device of claim 1, wherein
the memory further stores a position of a past waypoint in a past planned route and historical information of display settings corresponding to the position of the past waypoint, and
the processing circuitry is further configured to select display settings included in the historical information and change to the selected display settings.

10. The navigation information device of claim 2, wherein
the memory further stores a position of a past waypoint in a past planned route and historical information of display settings corresponding to the position of the past waypoint, and
the processing circuitry is further configured to select display settings included in the historical information and change to the selected display settings.

11. The navigation information device of claim 3, wherein
the memory further stores a position of a past waypoint in a past planned route and historical information of display settings corresponding to the position of the past waypoint, and
the processing circuitry is further configured to select display settings included in the historical information and change to the selected display settings.

12. The navigation information device of claim 4, wherein
the memory further stores a position of a past waypoint in a past planned route and historical information of display settings corresponding to the position of the past waypoint, and
the processing circuitry is further configured to select display settings included in the historical information and change to the selected display settings.

13. The navigation information device of claim 5, wherein
the memory further stores a position of a past waypoint in a past planned route and historical information of display settings corresponding to the position of the past waypoint, and
the processing circuitry is further configured to select display settings included in the historical information and change to the selected display settings.

14. The navigation information device of claim 6, wherein
the memory further stores a position of a past waypoint in a past planned route and historical information of display settings corresponding to the position of the past waypoint, and
the processing circuitry is further configured to select display settings included in the historical information and change to the selected display settings.

15. The navigation information device of claim 7, wherein
the memory further stores a position of a past waypoint in a past planned route and historical information of display settings corresponding to the position of the past waypoint, and
the processing circuitry is further configured to select display settings included in the historical information and change to the selected display settings.

16. The navigation information device of claim 1, wherein
the processing circuitry is further configured to perform machine learning using a position of the waypoint and display settings corresponding to the position of the waypoint as a learning parameter, wherein the memory stores display settings calculated by a classification model based on a location of the waypoint.

17. The navigation information device of claim 16, wherein the learning parameter further comprises at least one of displayed devices, ship speed, depth, direction, time, weather, and solar radiation as a ship passes through the waypoint.

18. A navigation information processing method comprising:
storing display settings that corresponds to a waypoint, which is a via point on a planned route;
acquiring position information of an own ship; and
performing a change process to change to display settings corresponding to the waypoint based on a positional relationship between the position information and the waypoint,
wherein the display settings include a setting for switching between at least two screens among a Global Positioning System (GPS) plotter device screen, a radar device screen, an automatic steering device screen, and a fish finder screen.

19. A non-transitory computer-readable medium having stored thereon computer-executable instructions which, when executed by a computer, cause the computer to:
acquire position information of an own ship;
store display settings corresponding to a waypoint that is a via point on a planned route;
generate a screen in which the position information is superimposed on a nautical chart; and
perform a change process to change to display settings corresponding to the waypoint based on a positional relationship between the position information and the waypoint,
wherein the display settings include a setting for switching between at least two screens among a Global Positioning System (GPS) plotter device screen, a radar device screen, an automatic steering device screen, and a fish finder screen.
